(19) United States
(12) Patent Application Publication
(10) Pub. No.: US 2013/0029195 A1
(43) Pub. Date: Jan. 31, 2013

(54) Energy Storage Apparatus and Method of Making Same with Paired Plates and Perimeter Seal

(71) Applicant: Steven L. Peace, Whitefish, MT (US)

(72) Inventor: Steven L. Peace, Whitefish, MT (US)

(73) Assignee: ZINC AIR INCORPORATED, Columbia Falls, MT (US)

(21) Appl. No.: 13/192,943

(22) Filed: Jul. 28, 2011

(51) Int. Cl. H01M 8/20; H01M 8/00; H01M 2/40

(52) U.S. Cl. 429/70; 29/623.1

(57) ABSTRACT

A stacked cell battery including anode plates and cathode plates that define an anolyte chamber and a catholyte chamber that are divided by a separator membrane. Perimeter flanges of the anode plate and cathode plate may define a seal retainer on the plate that extends between the perimeter flanges and the housing. Alternatively, an over-molded seal may be provided on the flanges of the anode plate and cathode plate that extends between the flanges and the housing.

### TECHNICAL FIELD

The present disclosure relates to an electrical charge storage system, and a method of making a stacked battery using paired plates that have oppositely charged plated surfaces.

### BACKGROUND

An electrical charge storage system includes one or more cells that store energy received from a source that charges the cell and releases the energy to a load by discharging the cell. Each cell has an anode and a cathode that an electrolyte flows across. Electrons in the electrolyte are transferred between the cathode and the anode to store energy in the system. The system is charged when current is applied to terminals causing electrons to flow from the cathode to the anode. Energy is discharged from the system when a load is applied to the terminals causing electrons to flow from the anode to the cathode.

Patents that were reviewed in conjunction with preparation of this disclosure include U.S. Pat. No. 6,841,047; U.S. Pat. No. 7,261,798; U.S. Pat. No. 7,354,675; and Published Application U.S. 2010/0279558. No representation is made that the listed references are the only or most relevant references to this disclosure.

### SUMMARY

An energy storage apparatus is disclosed that includes a housing that defines an inlet manifold and an outlet manifold for an anolyte and an inlet manifold and an outlet manifold for a catholyte. A plurality of anode plates are disposed between the inlet manifold and an outlet manifold for the anolyte. A plurality of cathode plates are disposed between the inlet manifold and an outlet manifold for the catholyte that are alternately attached to the plurality of anode plates about a perimeter of the anode plates and the cathode plates. A seal is disposed between the housing and the perimeter of the anode plates and the cathode plates. A separator membrane is disposed between the anode plates and the cathode plates that defines an anolyte passage for the flow of the anolyte and a catholyte passage for the flow of the catholyte between the separator membrane and the anode plate and the cathode plate, respectively. The membrane is impervious to the fluids but allows electrons to pass through the membrane and thereby charge and discharge the energy storage apparatus depending upon whether the energy storage apparatus is connected to a load or a source of power.

According to other aspects of the energy storage apparatus, an anolyte flow screen may be disposed in each of the anolyte passages and a catholyte flow screen may be disposed in each of the catholyte passages. Alternatively, a nickle foam member disposed in each of the catholyte passages and anolyte flow screen may be disposed in each of the anolyte passages.

According to further aspects of the energy storage apparatus, a plurality of spacers may be disposed between each of the anode plates and each of the cathode plates at spaced locations that hold the plates apart. The spacers may be formed integrally in the anode plates as indentations that are connected, structurally and electrically, to the cathode plate.

The seal of the energy storage apparatus prevents the catholyte on one side of the cathode plate from mixing with the anolyte on one side of the anode plate.

According to another aspect of the disclosure, a method of manufacturing an energy storage apparatus is disclosed. According to the method, at least one side of an anode plate is plated with a positive ion attracting plating material. At least one side of a cathode plate is plated with a negative ion attracting plating material. A plurality of spacers are provided between the anode plate and the cathode plate. A first flange is formed on the anode plate and a second flange is formed on the cathode plate that extend about the perimeter of the respective plates and are in contact with each other. The spacers hold the anode plate and cathode plate apart and provide an electrical connection between the anode plate and cathode plate. The first and second flanges are welded together and a seal is assembled to the first and second flanges and a housing to provide a sealed set of plates within the housing.

Another method of manufacturing an energy storage apparatus is disclosed that comprises the steps of plating at least one side of an anode plate with a positive ion attracting plating material and plating at least one side of a cathode plate with a negative ion attracting plating material. A first flange may be formed on the anode plate and a second flange may be formed on the cathode plate, wherein the first and second flanges extend about the perimeter of the respective plates and define a seal receptacle. Spacers disposed inboard of the flanges are in contact with each other and provide an electrical connection between the anode plate and cathode plate. The first and second flanges are welded together and a seal may be assembled to the seal receptacle defined by first and second flanges that extend between the first and second flanges and a housing to provide a sealed set of plates within the housing.

According to other aspects of either of the methods summarized above for manufacturing an energy storage apparatus, the spacers may be indentations and the method may further comprise integrally forming the indentations in the cathode plate and welding the indentations to the anode plate.

According to either of the methods, a plurality of the sealed set of plates may be assembled to the housing in series to provide a higher voltage level energy storage apparatus. In addition, a separator membrane may be assembled between each of the sets of plates. A flow screen may be assembled on one side of the separator membrane between the anode plate and the separator membrane. Alternatively, a nickel foam member may be assembled on one side of the separator membrane between the cathode plate and the separator membrane.

The above aspects of the disclosure should be understood to be examples of the apparatus and methods of manufacturing an energy storage apparatus and should not be understood to limit the broad scope of the disclosure. Other features and aspects of the disclosure will be better understood in view of the attached drawings and the following detailed description of the illustrated embodiments.

### BRIEF DESCRIPTION OF THE DRAWINGS

FIG. 1 is a diagrammatic view of a modular stacked battery energy storage system;

FIG. 2 is a fragmentary diagrammatic cross-sectional view of several cells of a modular stacked battery system; and

FIG. 3 is a fragmentary diagrammatic cross-sectional view of several cells of an alternative embodiment of a modular stacked battery system.

### DETAILED DESCRIPTION

A detailed description of the illustrated embodiments of the present invention are provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

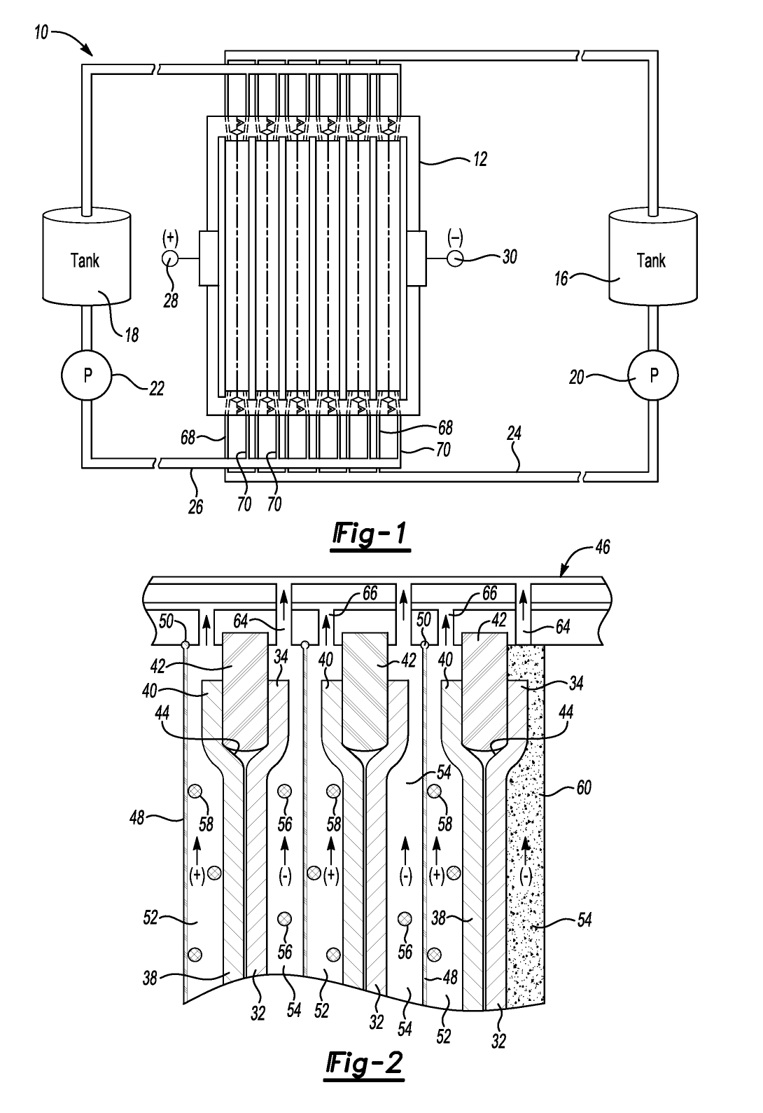

Referring to FIG. 1, a flow cell battery system 10 is shown that includes a modular stacked flow battery 12. An anolyte tank 16 and a catholyte tank 18 store and discharge energy through electrolytic fluids. An anolyte pump 20 and catholyte pump 22 circulate the electrolytic fluids through the battery 12. An anolyte fluid circuit 24 and catholyte fluid circuit 26 comprise piping or tubing that allow the electrolytic fluid to circulate and charge or discharge the system depending upon whether a load or charge is provided to the positive terminal 28 and negative terminal 30.

Referring to FIG. 2, a cathode plate 32 is shown to include a perimeter flange 34 that extends about the entire perimeter of the cathode plate 32. Anode plate 38 likewise includes a perimeter flange 40 that extends about the entire perimeter of the anode plate 38. A perimeter seal 42 is received in a seal receptacle 44 that is defined by the perimeter flange 34 of the cathode plate 32 and the perimeter flange 40 of the anode plate 38. The seal extends between the seal receptacle 44 and the housing 46 of the stacked battery cell 12 (shown in FIG. 1). A separator membrane 48 is attached to the housing 46 by a membrane seal 50. The separator membrane 48 divides the fluid filled space between the cathode plate 32 and the anode plate 38 into an anolyte chamber 52 and a catholyte chamber 54. An anode flow screen 58 is disposed in the anolyte chamber 52 and a cathode flow screen 56 is disposed in the catholyte chamber 54. Alternatively, a nickel foam medium 60 may be provided as shown on the right side of FIG. 2 instead of the cathode flow screen 56. The nickel foam medium 60 facilitates electron transfer to the cathode plate 32 and also provides turbulence that also promotes electron flow. The anolyte chamber 52 contains the anolyte fluid that flows to the anolyte outlet port 66 in the housing 46. Similarly, catholyte outlet port 64 receives catholyte from the catholyte chamber 54 that is recirculated as described with reference to FIG. 1 above.

Referring to FIG. 1, anolyte inlet port 68 and catholyte inlet port 70 are provided in the housing 46 (shown in FIG. 2). Anolyte and catholyte fluids are provided through the inlet ports 68 and 70 to the anolyte chamber 52 and catholyte chamber 54.

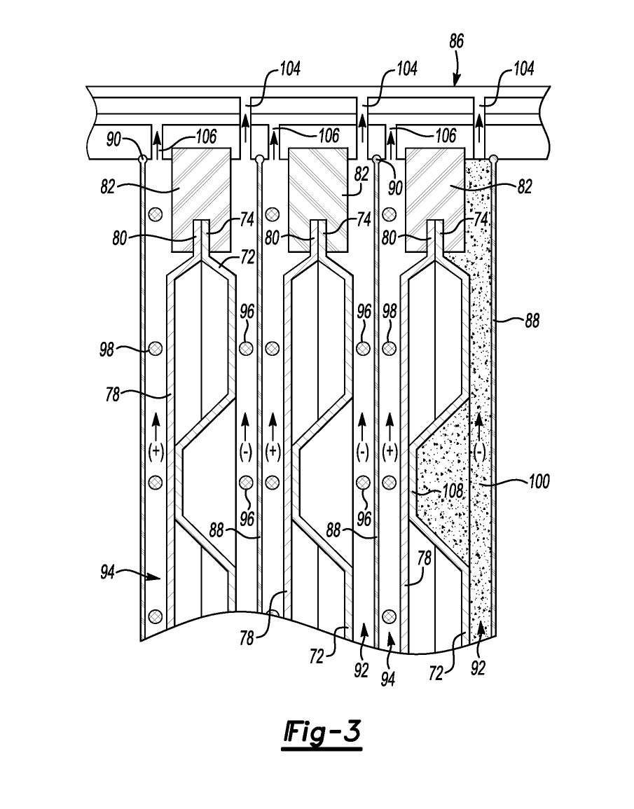

Referring to FIG. 3. an anode plate 78 is shown that includes a perimeter flange 80. A cathode plate 72 includes a perimeter flange 74. The perimeter flanges 74 and 80 are welded or otherwise secured to each other. An over-molded perimeter seal 82 is molded onto the perimeter flange 80 of the anode plate 78 and the perimeter flange 74 of the cathode plate 72. The over-molded perimeter seal 82 extends between the perimeter flanges 74, 80 and the housing 86. Alternatively, the seal 82 could be separately formed and mechanically attached to the flanges 74 and 80 to provide a seal.

A separator membrane 88 is connected by a membrane seal 90 to the housing 86. The separator membrane 88 divides the area between the anode plate 78 and the cathode plate 72 into an anolyte chamber 94 and a catholyte chamber 92. The anolyte and catholyte flow through the anolyte chamber 94 and catholyte chamber 92, respectively.

An anode flow screen 98 and a cathode flow screen 96 are disposed in the anolyte chamber 94 and the catholyte chamber 92, respectively. Instead of providing a cathode flow screen 96, it may be advantageous to place a nickel foam medium 100, as shown in the right-most catholyte chamber as illustrated in FIG. 3. The nickel foam medium 100 is provided to facilitate transfer of electrons to and from the cathode plate 72.

The anolyte, after passing through the anolyte chamber 94, flows into anolyte outlet ports 106. Catholyte outlet ports 104 receive catholyte from the catholyte chamber 92.

The cathode plate 72 may be provided with integrally formed hub spacers 108 that are formed in the cathode plate 72. The spacers 108 reinforce the cathode plate 72 and prevent the cathode plate 72 and anode plate 78 from being deformed towards each other in response to the pressure in the anolyte chamber 94 and catholyte chamber 92.

The anode plate 78 and cathode plate 72 are separately plated and may be plated on one or both sides. The cathode plate 72 is preferably provided with a nickel plating, or the like, and the anode plate 78 is preferably provided with a cadmium plating, or the like. The plates 72 and 78 may be plated on both sides to eliminate the labor required to mask the plates during the plating process. The plating applied to the inner or facing surfaces of the plates 72 and 78 does not contact the anolyte or catholyte and does not adversely effect charging or discharging the electrical charge storage system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An energy storage apparatus comprising:
a housing that defines a first inlet manifold and a first outlet manifold for an anolyte and a second inlet manifold and a second outlet manifold for a catholyte;
a plurality of anode plates disposed between the first inlet manifold and the first outlet manifold;
a plurality of cathode plates disposed between the second inlet manifold and a second outlet manifold for the catholyte that are alternately attached to the plurality of anode plates about a perimeter of the anode plates and the cathode plates;
a seal disposed between the housing and the perimeter of the anode plates and the cathode plates; and
a separator membrane disposed between the anode plates and the cathode plates that defines an anolyte passage for the flow of the anolyte and a catholyte passage for the flow of the catholyte between the separator membrane and the anode plate and the cathode plate, respectively, wherein the separator membrane is impervious to the fluids and allows electrons to pass through the membrane and thereby charge and discharge the energy storage apparatus depending upon whether the energy storage apparatus is connected to a load or a source of power.

2. The energy storage apparatus of claim 1 further comprising an anolyte flow screen disposed in the anolyte passage and a catholyte flow screen disposed in the catholyte passage.

3. The energy storage apparatus of claim 1 further comprising a nickle foam member disposed in the catholyte passage and a anolyte flow screen disposed in the anolyte passage.

4. The energy storage apparatus of claim 1 further comprising a plurality of spacers disposed between each of the anode plates and each of the cathode plates at spaced locations that hold the plates apart.

5. The energy storage apparatus of claim 4 wherein the spacers are formed integrally in the catholyte plates as indentations that are structurally and electrically attached to the anode plate.

6. The energy storage apparatus of claim 1 wherein the seal prevents the catholyte on one side of the cathode plate from mixing with the anolyte on one side of the anode plate.

7. A method of manufacturing an energy storage apparatus comprising the steps of:
plating at least one side of an anode plate with a positive ion attracting plating material;
plating at least one side of a cathode plate with a negative ion attracting plating material;
providing a plurality of spacers between the anode plate and the cathode plate;
forming a first flange on the anode plate and a second flange of the cathode plate, wherein the first and second flanges extend about the perimeter of the respective plates and are in contact with each other, and wherein the spacers hold the anode plate and cathode plate apart and provide an electrical connection between the anode plate and cathode plate;
welding the first and second flanges together; and
assembling a seal to the first and second flanges that extends between the first and second flanges and a housing to provide a sealed set of plates within the housing.

8. The method of claim 7 wherein the spacers are indentations and the method further comprises integrally forming the indentations in the cathode plate; and
welding the indentations to the anode plate.

9. The method of claim 7 further comprising:
assembling a plurality of the sealed set of plates to the housing in series to provide a higher voltage level energy storage apparatus.

10. The method of claim 9 further comprising:
assembling a separator membrane between each of the sets of plates.

11. The method of claim 9 further comprising:
assembling a flow screen between the cathode plate and the separator membrane.

12. The method of claim 9 further comprising:
assembling a nickle foam member on one side of the separator membrane between the cathode plate and the separator membrane.

13. A method of manufacturing an energy storage apparatus comprising the steps of:
plating at least one side of an anode plate with a positive ion attracting plating material;
plating at least one side of a cathode plate with a negative ion attracting plating material;
forming a first flange on the anode plate and a second flange of the cathode plate, wherein the first and second flanges extend about the perimeter of the respective plates and define a seal receptacle groove, and wherein portions of the plates that are inboard of the flanges are in contact with each other and provide an electrical connection between the anode plate and cathode plate;
welding the first and second flanges together; and
assembling a seal to the seal receptacle defined by first and second flanges that extends between the first and second flanges and a housing to provide a sealed set of plates within the housing.

14. The method of claim 13 further comprising:
assembling a plurality of the sealed set of plates to the housing in series to provide a higher voltage level energy storage apparatus.

15. The method of claim 14 further comprising:
assembling a separator membrane between each of the sets of plates.

16. The method of claim 15 further comprising:
assembling a flow screen on one side of the separator membrane between the cathode plate and the separator membrane.

17. The method of claim 15 further comprising:
assembling a nickle foam member on one side of the separator membrane between the cathode plate and the separator membrane.
